(19) United States
(12) Patent Application Publication
(10) Pub. No.: US 2007/0115099 A1
(43) Pub. Date: May 24, 2007

(54) Image processing system for identifying car thieves

(76) Inventor: Nobutaka Hamada, Aichi (JP)

Correspondence Address: CLARK & BRODY, 1090 VERMONT AVENUE, NW, SUITE 250, WASHINGTON, DC, 20005, US

(21) Appl. No.: 10/568,590

(22) PCT Filed: Jul. 6, 2004
(86) PCT No.: PCT/JP04/09559

§ 371 Date: Nov. 3, 2006

(30) Foreign Application Priority Data
Aug. 20, 2003 (JP) 2003-295993

(51) Int. Cl. H04N 7/18; B60R 25/10

(52) U.S. Cl. 340/426.1; 348/151

(57) ABSTRACT

An image processing system for identifying car thieves is set in a car and comprises a device to take clear and full-faced images of a criminal without the criminal's knowledge. The image processing system for identifying car thieves comprises a dashboard panel (10) being provided in front of the driver's seat, a candid camera (30) being provided behind the dashboard panel (10), and an infrared light projector (35) to emit infrared light toward the driver's seat. The system also includes a hole (H) provided at a specific point on the dashboard panel (10), the candid camera 30 being set behind the hole (H) facing the driver's seat, and the hole (H) being covered with a half-transparent protectively-colored cover (25), with infrared transparency of the similar or same color as that of the surface color of the dashboard panel (10).

### FIELD OF THE INVENTION

This invention relates to an image processing system for identifying car thieves, which is set specifically in a car and automatically takes the images of the thieves sitting in the driver's seat.

### BACKGROUND OF THE INVENTION

In general, when a cash transport car, or the like is stolen, the hints to identify the thief are his physiognomy, his voice, or his clothes that the passenger or witness at the scene of the theft noticed or obtained, or fingerprints or personal effects that the thief left behind.

However, human memory is not infallible. Even more so if a man suddenly confronted with an unexpected event, or if he is placed in sudden danger.

Moreover, it requires much time and work to examine fingerprints and to ascertain the personal effects of a suspect. Therefore, sometimes the criminal cannot be identified before the statute of limitations expires.

The conventional system for identifying a car thief entails a security camera being installed in a car as described in:

Reference 1: Japanese Patent Application No. 2000-6762,

Reference 2: Japanese Patent Application No. H09-193711, and

Reference 3: Japanese Patent Application No. 2001-322533.

For instance, Reference 1 shows how a security camera is to be installed in the rear-view mirror of the car for recording any criminal act, and Reference 2 shows how a security camera is to be installed in the side-view mirror of the car for preventing the car from being stolen.

### PROBLEMS TO BE RESOLVED BY THE INVENTION

However, the camera system can easily be found by the criminal, and such cameras may be destroyed by the criminal before he runs away. Or he should take the film, then there would be no evidence to verify.

On the other hand, a security camera for the aforementioned system can be installed in the trunk, or in any seat, or behind the dashboard panel, (as shown in Reference 3), or in another place which may not easily be found by the criminal. However, a camera installed in such places may not take an image of the criminal whatsoever, or a clear image of the criminal if it is dark. Therefore, it would be difficult to identify the criminal.

Given the above circumstances, this invention is to provide an image processing system for identifying car thieves, which is to be installed in a car and comprises a device for taking clear and full-faced images of the criminal without him knowing it.

### MEANS OF SOLVING THE PROBLEMS

The image processing system of this invention (Invention 1) for identifying car thieves and to solve the aforementioned problems is characterized by comprising a dashboard panel to be provided in front of the driver's seat, a candid camera installed in the back of the dashboard panel, and an infrared light projector to emit a ray of infrared light toward the driver's seat. This system is also characterized by comprising a hole being provided at a specific position on the dashboard panel so that the candid camera is appropriately set on the other side of the hole facing the driver's seat, and that the color of the translucent material which covers the hole is similar to the surface color of the dashboard panel.

This invention (Invention 1) for identifying car thieves comprises a structure in which the candid camera is set behind a hole made in the dashboard panel so that the full-faced image of a criminal sitting in the driver's seat can be easily and certainly taken. Even if it is dark, the full-faced image of the criminal can clearly be taken due to the infrared light being emitted from the infrared light projector.

As the protectively-colored cover of the hole will be of a surface color of the dashboard, the candid camera installed behind the hole will not easily be found by the criminal.

The image processing system of this invention (Invention 2) for identifying car thieves is characterized by an infrared light projector being installed behind a hole made in the dashboard panel facing the driver's seat.

To provide that a ray of infrared light be emitted toward the driver's seat, the infrared light projector, for instance, can be incorporated as an accessory of the dashboard panel, or it can be installed in the control panel of the air conditioner, or in the car navigation system or the like.

However, if the infrared light projector is installed outside the dashboard panel, it may hinder the car owner from driving the car. Also the criminal may notice the security device.

In the invention (Invention 2), the hole, behind which the infrared light projector is installed is covered with the protectively-colored cover in the same way that the hole behind which the candid camera is covered. Therefore, the infrared light projector cannot be seen from the driver's seat, and the above problems are resolved.

The image processing system of this invention (Invention 3) for identifying car thieves is characterized by the protectively-colored cover being provided on the display background of the numbers, characters, symbols, or the like, of the dashboard panel so that the protectively-colored cover will be assimilated with the gauge indications.

Normally, the vehicle speed and engine revolutions are numerically displayed on the dashboard panel. In general, the display colors of such gauge indications are more visually distinguished from the background colors of the dashboard panel. In the invention (Invention 3), the protectively-colored cover is provided in the proper position where said cover should be assimilated into the background of the numbers, the characters, the symbols, or the like, so that the driver notices only the indications i.e. the numbers, the characters, the symbols, or the like. Thus, the driver will not notice the hole of the protectively-colored cover. Therefore, the protectively-colored cover will not easily be discovered by a criminal.

Also, in the invention (Invention 3), to assimilate the hole and the protectively-colored cover into the background of the numbers, characters, symbols or the like on the dashboard, the hole and the protectively-colored cover preferably can be positioned inside a circular line described as a number “0”, “8” or the like. Normally, drivers look at the whole part of such numbers. They don't stare at a particular part of the displayed number. Therefore, the hole and the protectively-colored cover installed over the area described above will not easily be discovered by a criminal.

The image processing system of this invention (Invention 4) for identifying car thieves is characterized by the protectively-colored cover which is shaped like a convex lens being projected toward the driver's seat.

In the case where the distance between the hole on the dashboard and the driver is short and the field of vision is narrow, the image of the driver may not be taken.

On the other hand, it is possible to take the image of the driver from a broad angle by a camera with fish-eye lens. However, the cost of manufacturing such a camera is high, which would make it economically difficult to install such an image processing system for identifying car thieves in ordinary cars such as passenger cars, or the like.

Therefore, in this invention (Invention 4), a protectively-colored cover that is shaped like a convex lens, bulging toward the driver's seat, is used so that the field of vision can be expanded up to 180 degrees and an image can be taken from a broad angle through the camera. Thus, the image of the criminal can be taken clearly regardless of the criminal's body type or driving position. Therefore, the reliability of the image processing system is improved.

In the above inventions (Inventions 1 to 4), the candid camera starts taking a moving image from standby mode that is activated by the prior-switch operation in the vicinity of the driver's seat when a criminal opens the door to steal the car. Then, the camera stops operating when the criminal opens the door again to exit the car after he has stopped car and turned off the engine.

Thus, the camera is activated from standby mode and takes the moving image of the criminal all the time when the criminal first sits in the driver's seat till he leaves the car. Also, the candid camera is turned on or off as the criminal moves in the car, so that the mechanical sound of the camera cannot be heard by the criminal. Thus, the camera cannot easily be discovered by the criminal.

The candid camera preferably takes the image of the criminal sitting in the driver's seat in the following two ways:

a. The criminal sits in the driver's seat and turns the key to start the engine, or

b. The criminal steps on the brake pedal, thus turning on the brake lights.

Thus, the full-faced image of the criminal can be taken while he is moving in the car as described above. Also, the line of sight, behavior or the like can also be recorded, which makes it easier to identify the car thief. Furthermore, when the criminal acts as described above, the camera shutter clicks. However, the sound of clicking the candid camera will not be heard by the criminal. Therefore, it will be difficult for the criminal to detect the camera.

The inventive candid camera preferably comprises a means of transmitting still images of the criminal sitting in the seat to the computer or to the mobile terminal of the car owner.

Thus, the car owner can check the image of the criminal on his mobile terminal such as a cellular phone or the like, immediately after the car is stolen. Therefore, the car owner is able to quickly report the crime to the police, which will result in the crime being promptly solved.

The candid camera is preferably stored in the indicator light case of the dashboard panel, and at the same time the hole is preferably provided on a light cover of the indicator light case. Also, the hole is preferably covered with a protectively-colored cover of a similar color to that of the cover.

As described above, the candid camera can easily be stored in a small space, i.e. the indicator light case. Also, the candid camera will not easily be found by a criminal since the hole is covered with a protectively-colored cover having a similar color to that of the light cover.

The candid camera is securely fixed by a screw or the like preferably on a partition wall of the meter housing in the dashboard panel. Therefore, the candid camera will not be jolted loose even if the car is driven over rough roads. Also, the meter housing has a comparatively large space so that the candid camera can easily be fixed inside.

An imitation of the protectively-colored cover can also be provided at a specific place of the dashboard panel. Thus, the criminal cannot identify the position of the real camera even if he should be aware of this type of inventive system for identifying car thieves. Therefore, the hole is not likely to be covered by the criminal. The imitation protectively-colored cover is of the same color and shape as that of the protectively-colored cover.

The car thief identifying system in these inventions (Inventions 1 to 4) can be used in special cars, such as patrol cars or delivery vehicles that carry cash or other valuable goods i.e. paintings, jewelry, or the like, as well as ordinary passenger cars. Especially, the same system can be used in expensive luxury cars which are more likely to be stolen. Also, these inventions (Inventions 1 to 4) can be applied to trains, airplanes, or other means of transport

These inventions (Inventions 1 to 4) can be used individually or in combination.

### BRIEF DESCRIPTION OF THE DRAWINGS

FIG. 1 is the front view of a dashboard panel in Embodiment 1 of this invention.

FIG. 2 is a cross-sectional view of a dashboard panel in Embodiment 1 of this invention.

FIG. 3 is a partially enlarged front view of a speedometer in Embodiment 1 of this invention.

FIG. 4 is a circuit diagram of the car thief identifying system in Embodiment 1 of this invention.

FIG. 5 is a flow chart showing the procedure for taking the image of a criminal by the car thief identifying system of Embodiment 1.

FIG. 6 is a cross-sectional view of a dashboard panel in Embodiment 2 of this invention.

FIG. 7 is a cross-sectional view of a dashboard in Embodiment 3 of this invention.

FIG. 8 is a cross-sectional view of a dashboard in Embodiment 4 of this invention.

### DESCRIPTION OF ALPHANUMERIC CODE

10 Dashboard panel
12 Front panel
13 Case
15 Speedometer
16 Tachometer
21 Meter panel
22 Clear panel
23 Vehicle speed signal converter
23a Meter axis
24 Meter needle
25 Protectively-colored cover
30 Candid camera
31 Camera eye
33 Image data recording device
35 Infrared light projector
41 Battery
H Hole
K Through-hole

### DETAILED DESCRIPTION OF PREFERRED EMBODIMENTS

The embodiments of this invention will now be described according to the drawings. The embodiments here show that the invention is applied to the dashboard panel for passenger cars.

### Embodiment 1

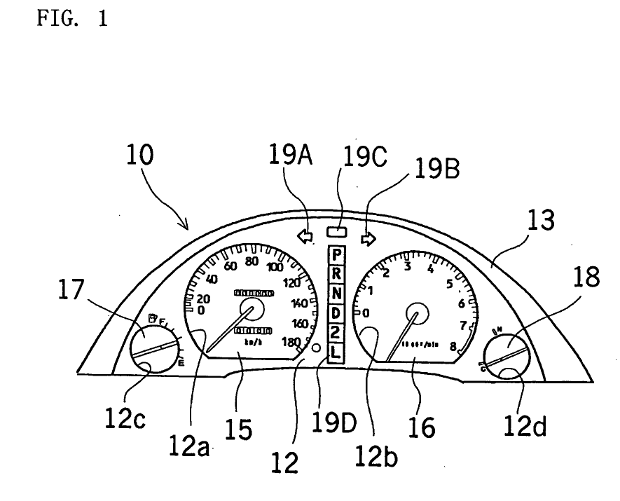

As shown in FIG. 1, a dashboard panel 10 comprises a synthetic-resin case 13, therein a front panel 12 is provided. A speedometer 15 and a tachometer 16 are symmetrically provided on the front panel 12. A fuel gauge 17 is provided on the left side of the speedometer 15, and a temperature gauge 18 is provided on the right side of the tachometer 16. Window frames 12a, 12b, 12c, and 12d are respectively open on the surface of the front panel 12. Each gauge indication can be seen through window frames 12a, 12b, 12c, and 12d.

Various indicator lights are provided on the front panel 12. In other words, the turn signal lights 19A and 19B and the high beam light 19C are provided slightly above the speedometer 15 and the tachometer 16, and a vertically-shaped gear indicator 19D is provided between the speedometer 15 and the tachometer 16.

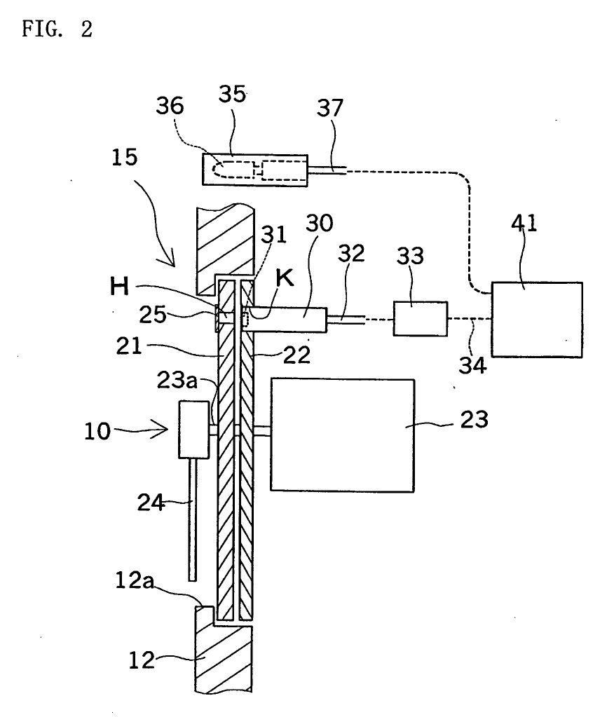

As shown in FIG. 2, a vehicle speed signal converter 23 is provided behind the meter panel 21 and the clear panel 22 of the speedometer 15. The meter panel 21 and the speed panel 22, aligned together with a slight clearance between them are provided on the window frame 12a of the front panel 12. A meter axis 23a with an attached meter needle 24 on its end extends to the front of the vehicle speed signal converter 23 and goes through the meter panel 21 and the clear panel 22. A vehicle speed signal is converted into a rotation angle of the meter axis 23a, and the meter needle 24 rotates to the vehicle speed.

The surface color of the meter panel 21 is to be a dark color, i.e. black, navy blue, or the like which should be similar to the color of the front panel 12. As shown in FIG. 1, numbers and other scales on the meter panel 21 for indicating the speed are bright colors, i.e. white, orange or the like which stand out against the dark meter panel 21.

The clear panel 22 is made of transparent materials such as acryl or the like and is almost the same size as the meter panel 21. A back light is provided on the back of the clear panel 22 (not shown in the drawing). The light from the back light is diffused by the clear panel 22 so that the meter panel 21 is illuminated. Thus, the driver can see the indication of the meter panel even at night.

As shown in FIG. 2, a hole H is provided in the upper end of the meter panel 21.

The diameter of the hole H is a few millimeters and nearly vertically penetrates the meter panel 21. A protectively-colored cover 25 is attached to the surface of the meter panel 21 to cover up the hole H.

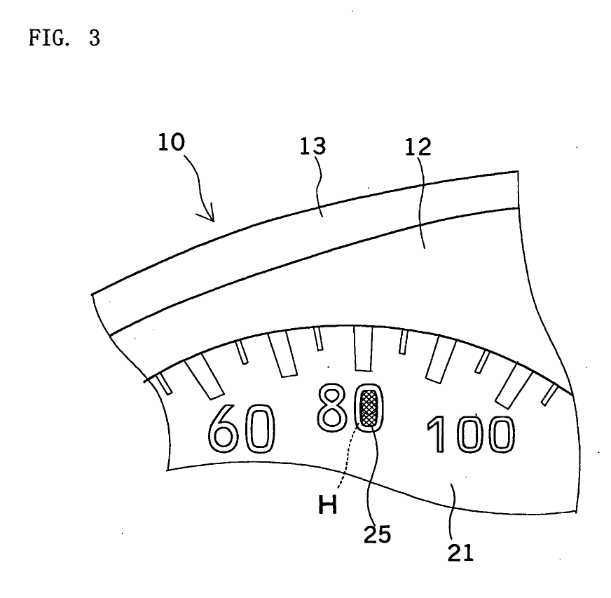

As shown in FIG. 3, the hole H and the protectively-colored cover 25 are both provided at the upper end of the speedometer 15 where the numbers are indicated.

In this embodiment, the hole H and the protectively-colored cover 25 are both provided inside the “0” of the number “80” which stands for 80 kilometers per hour. And the protectively-colored cover 25 is attached to the top of the number “0”.

Thus, the hole H is provided on the comparatively higher place of the speedometer 15 so that the image of the driver's upper body and face can be taken clearly by a candid camera 30, hereinafter to be described. Thus, the protectively-colored cover 25 is assimilated into the background of the numbers so that the hole H and the protectively-colored cover 15 cannot easily be discovered by the driver.

The protectively-colored cover 25 is made of a transparent resin film comprising an infrared transparency. The color of the resin film is similar to the surface (background) color of the meter panel 21, i.e. a dark color is used for the entire surface of the resin film. Thus, the outer surface of the protectively-colored cover 25 is similar to the color of the meter panel 21 so that the protectively-colored cover 25 and the hole H can hardly be noticed by the person sitting in the driver's seat.

As shown in FIG. 2, the candid camera is provided close behind the hole H. The front tip of the camera 30 is inserted into the through-hole K of the clear panel 22. Thus, the candid camera 30 can be firmly fixed behind the hole H of the dashboard panel 10.

The camera lens 31 of the candid camera 30 is set to focus on the driver's seat through the protectively-colored cover attached to the hole H. Since the hole H is covered with the protective colored cover 25, the candid camera 30 cannot be noticed by the person sitting in the driver's seat. A CCD camera, or a C-MOS camera, or the like on the market is used for the candid camera 30.

An image data recording device 33 is provided behind the candid camera 30. An image signal taken by the candid camera 30 is transferred to the image data recording device 33 via a cable 32, and recorded as a still image or a moving image. As a recording media for the image data recording device 33, a magnetic recording media for digital cameras, or the like is used.

In addition, an infrared light projector 35 is provided in the front area of the car. The infrared light projector 35 incorporates a special LED for emitting the infrared light toward the driver's seat. The infrared light projector 35 can be installed anywhere around the instrument panel, dashboard or the like so as not to hinder the person from driving.

The candid camera 30, the image data recording device 33, and the infrared light projector 35 are connected to the car battery 41 via cables 32, 34, and 37. Once an electric current is supplied from the battery 41, the camera will start operating regularly.

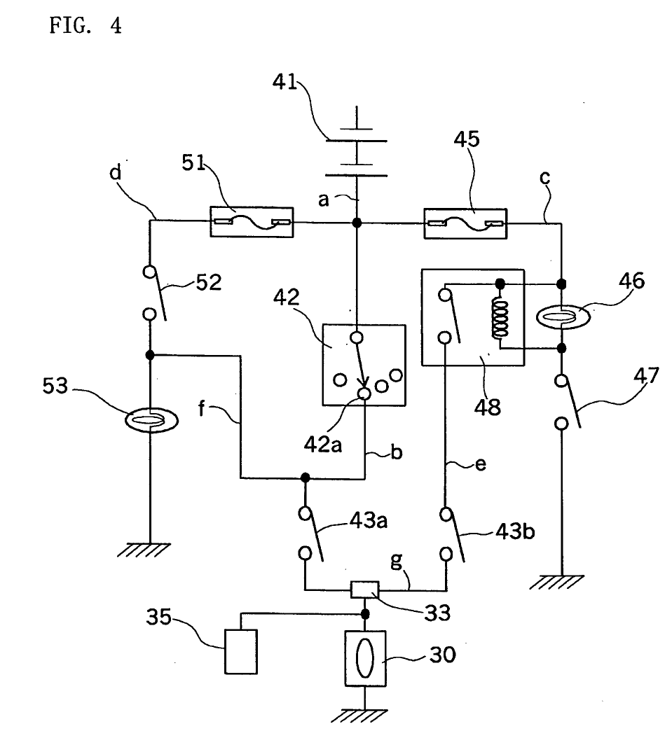

An example of the circuit diagram is shown in FIG. 4.

FIG. 4 shows that the candid camera 30 will start operating at any time when the ignition key switch 42 is turned on, or the door switch 47 is turned on, or the stop light switch 52 is turned on.

As shown in FIG. 4, an on-contact point 42a of the ignition key switch 42 is connected to the main power circuit a which is connected to the battery 41. A manual switch 43a is connected to the on-contact point circuit b so that the candid camera 30 and the image data recording device 33 can be switched to standby mode.

On the other hand, the door switch circuit c, being connected to the interior light fuse 45, and to the interior light 46 itself, and to the door switch 47 is diverged from the main power circuit a. The door switch circuit c is connected to the manual switch 43b via the auxiliary circuit e running from the relay switch 48. When the door switch turns on, the interior light 46 also turns on, and the relay switch 48 is closed so that the electric current flows into the door switch circuit c and into the auxiliary circuit e.

Also, the stop light circuit d with the stop light fuse 51, and the stop light switch 52 and the stop light 53 is diverged from the main power circuit a. The stop light circuit d is connected to the manual switch 43a via the auxiliary circuit f. When the stop light switch 52 turns on, the stop light 53 also turns on so that the electric current flows into the stop light circuit d and the auxiliary circuit f.

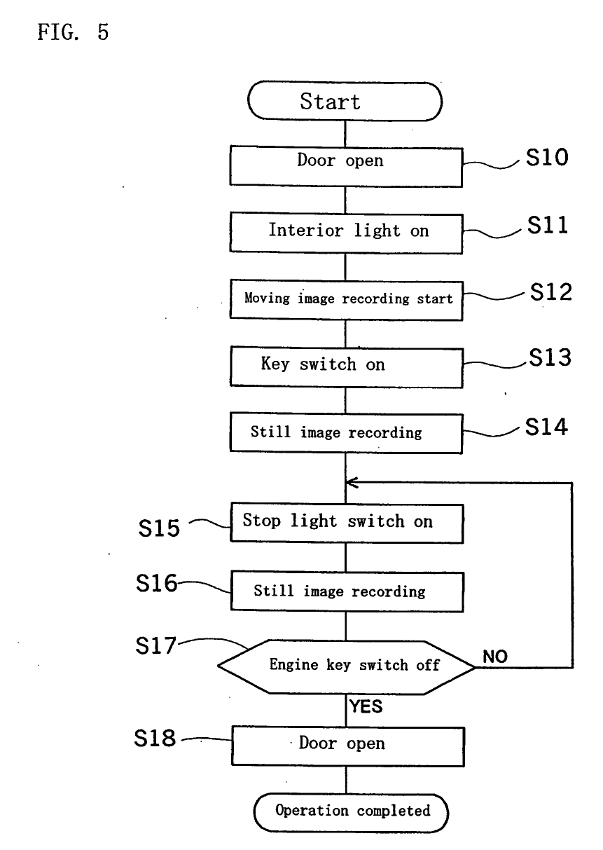

Next, the operational procedure of the inventive car thief identifying system is herein described by the flow chart of FIG. 5. The procedure described below is only an example of how the candid camera operates. The shooting time, or the like can be altered if necessary.

First of all, the owner of the car should turn on the manual switches 43a and 43b which are provided in the vicinity of the driver's seat before he leaves the car so that the candid camera 30 will be set on standby mode.

If somebody tries to steal the car by opening the car door without permission from the car owner (Step S10), the interior light turns on (Step S11), and an electric current from the battery 41 flows into the candid camera 30, and into the image data recording device 33, and into the infrared light projector 35 via the main power circuit a, and via the door switch circuit c, and via the auxiliary circuit e. Then, the candid camera 30 starts taking the moving image of the thief in the driver's seat, and the image data is recorded in the image data recording device 33 (Step S12).

Secondly, should a car thief sit in the driver's seat and turn on the ignition key switch 42 to the on-contact point 42a (Step S13), so that an electric current from the battery 41 flows into the candid camera 30 via the main power circuit a and via the on-contact circuit b, then the camera shutter is released and the still image is recorded in the image data recording device 33 provided on the driver's side (Step S 14).

Also, when the car thief presses the brake pedal, the stop light switch 52 turns on (Step S1), and an electric current from the battery 41 flows into the candid camera 30 via the stop light circuit a, via stop light circuit d and via the auxiliary circuit f. Then, the camera shutter is released and the still image as well as the status of the ignition switch on-contact point (Step S13) are recorded in the image data recording device 33 (Step S16).

Also, the still-image data which is recorded in the image data recording device 33 can accordingly be transferred to mobile terminals such as computers, cellular phones, or the like.

Before the criminal exits the car, he must stop the car and turn off the ignition key switch 42 (YES of Step S17), and then open the door (Step S18). At this time, the electric current which is flowing to the candid camera 30 and to the image data recording device 33 and to the infrared light projector 35, is cut off so that the taking of the moving image by the candid camera 30 is stopped. As the car is being driven, the stop light switch 52 turns on every time the car thief presses the brake pedal (No of Step S17). Thus, a still image of the criminal is repeatedly being recorded in the image data recording device 33.

The car thief who is sitting in the driver's seat will see the dashboard panel 10, but he will not be able to detect the candid camera 30 since the hole H is covered with the protectively-colored cover 25. Furthermore, the protectively-colored cover 25 will not be noticed since the color of the protectively-colored cover is similar to the color of the speedometer 15.

Also, when the car thief begins stealing the car, in other words, when he turns the ignition key switch 42 to the on-contact point, or when he presses the brake pedal, the camera shutter is released. However, the sound of the camera shutter will be drowned out by the sounds caused by his actions.

Thus, the image of the criminal will surely be taken by the candid camera 30 without him knowing it.

Furthermore, even if it is dark, the image of the criminal sitting in the driver's seat will surely be taken by the candid camera through the protectively-colored cover by the infrared light being emitted from the infrared light projector. Thus, the clear image of the criminal will surely be recorded in the image data recording device 33.

### Embodiment 2

Another embodiment of this invention is herein described.

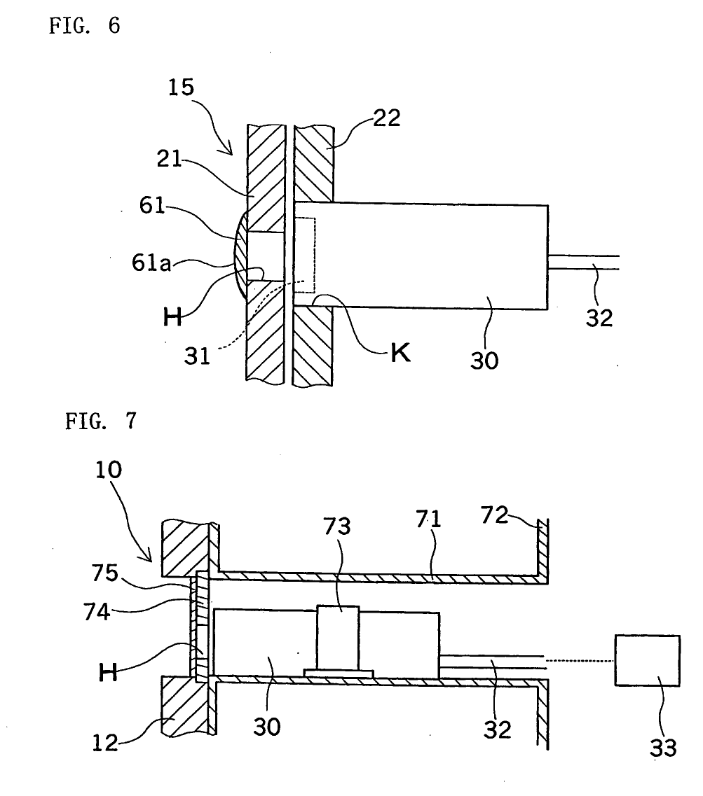

The inventive car thief identifying system shown in FIG. 6 comprises a convex-lens-shaped protectively-colored cover 61.

A hole H is provided on a meter panel 21 of a speedometer 15. A through-hole K is provided in a clear panel 22 located behind the meter panel 21. The front tip of the candid camera 30 is firmly pressed into the through-hole K. The camera lens 31 of the candid camera 30 is set so as to focus on the driver's seat through the hole H. And a convex-lens-shaped protectively-colored cover 61 is attached to the front surface of the meter panel 21 so as to cover the hole H.

The protectively-colored cover 61 is made of a half-transparent resin material with infrared transparency and is of the same color as the background color of the meter panel 21. The surface 61a of the protectively-colored cover 61 is of a convex shape projecting toward the driver's seat. The camera axis of the candid camera 30 is positioned near the center of the convex surface 61a. The protectively-colored cover 61 can be made of resin materials such as acryl, or the like so that it can be manufactured at a relatively low cost.

Thus, the protectively-colored cover 61 with a convex-shaped lens positioned before the candid camera 30 has the same effect as a wide-angle fisheye lens. In other words, a wide-angle image of the driver's seat can be taken by the candid camera 30, which means that the image of the criminal will surely be taken. For example, even if the body shape or driving posture of a given car thief is different, and he is not positioned right in front of the camera 30, an image of his face which is important to have to identify the criminal will be taken.

### Embodiment 3

FIG. 7 shows a device for identifying a car thief in which the candid camera 30 is stored in an indicator light case 71.

Indicator lights for showing the operating conditions of the headlights, the seat belt or the like may also be provided on the dashboard panel. Each indicator light is positioned in one of indicator light cases formed by the divisions of the meter housing. The settings of these indicator lights differ according to the type of car, and many of the settings may be empty. In this embodiment, the candid camera 30 is placed in an unused indicator light case.

Referring to the dashboard panel 10 shown in FIG. 7, a meter housing 72 to store the gauges is provided behind the front panel 12. The indicator light case 71 is incorporated in the meter housing 72. The candid camera 30 is placed in the indicator light case 71 and affixed at the bottom of the indicator light case 71 with a bracket 73. In this embodiment, no light source for the indicator light is placed in the indicator light case. 71.

A light cover 74 is placed at the opening of the indicator light case 71. The light cover 74 is of a specific color so that the inside of the indicator light case 71 cannot be revealed from the driver's seat.

The hole H passing through the light cover 74 is provided in front of the candid camera 30. The image of the driver's seat area can be taken by the candid camera 30 through the hole H. A protectively-colored transparent cover 75 which covers the hole H is attached to the front surface of the light cover 74. The protectively-colored cover 75 is made of a resin film and is of the similar or the same color as the light cover 74 and is of an infrared transparency.

In this third embodiment, the candid camera can easily be placed in an existing indicator light case of any type of vehicle. Also, the color of the protectively-colored cover 75 can easily be changed to that of the color of any light cover 74 so that a candid camera cannot easily be discovered by a criminal.

### Embodiment 4

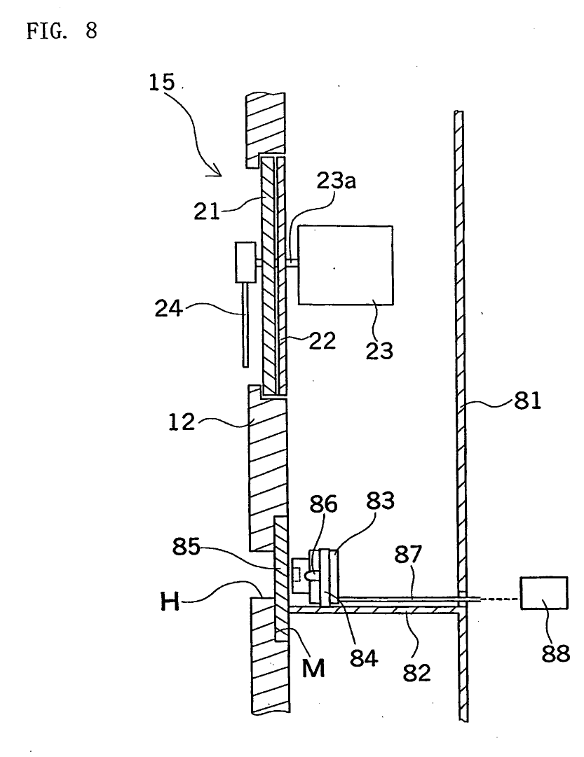

FIG. 8 shows another embodiment in which a candid camera 83 is attached to a partition wall 82 in the meter housing 81.

As shown in FIG. 8, a meter gauge such as a vehicle speed signal converter 23 or the like is stored in the meter housing 81. The partition wall 82 extends from the back of the meter housing 81 to the front panel 12. The candid camera 83 is affixed to the forward end of the partition wall 82 by a bracket 84 and a screw or the like.

A hole H is provided on the front panel 12, which is positioned in front of the candid camera 83. A concave groove M is formed around the hole H at the back side of the front panel 12. A protectively-colored cover 85 is inserted in the concave groove M. In other words, the hole H is covered with a protectively-colored cover 85 at the back side of the front panel 12.

The protectively-colored cover 85 is made of a half-transparent resin panel such as acryl, or the like which is of the similar or the same color as the background color of the front panel 12, so that the protectively-colored cover 85 will not easily be detected by a person sitting in the driver's seat.

The candid camera 83 incorporates an image recording device which is connected to an image transmitter 88 via a cable 87. As a moving image is being recorded through the candid camera 83, a still image can be transmitted to the owner of the car at regular intervals. In this invention CCD cameras, C-MOS cameras, or the like which are commercially available can be used for the candid camera 83.

An infrared light projector 86 is provided in the vicinity of the lens of the candid camera 83. A ray of infrared light from the infrared light projector 86 is beamed toward the driver's seat area through the protectively-colored cover 85. Such an infrared light projector 86, provided behind the dashboard panel, does not hinder the driver from driving the car. Also, the infrared light projector 86 cannot be seen by someone sitting in the driver's seat. Therefore, it is more difficult for a criminal to detect the inventive device for identifying car thieves.

In this embodiment characterized by the candid camera 83 being installed on the partition wall 82 of the meter housing 81, space for installing the candid camera 83 is sufficiently available. Thus, as described above, a multifunctional candid camera 83 can easily be installed, and an infrared light projector 86 can easily be set behind the protectively-colored cover 85.

Furthermore, the candid camera 83 can be installed at various positions, and the image processing system for identifying car thieves can be installed easily in various types of cars easily.

### Other Embodiments

This invention includes, without limitation, the aforementioned embodiments 1 to 4. The position for the hole or protectively-colored cover can be changed according to the type of car.

To make it hard for a car thief to detect the candid camera, an obscure protectively-colored cover can be provided on the front panel. For instance, the Embodiment 1 invention is characterized by the protectively-colored cover being assimilated in the number “80”. The protectively-colored cover is attached to the inner side of the “0” so that the candid camera cannot easily be detected.

Furthermore, in the Embodiment 4 invention, the candid camera 83 can be integrally fixed by applying adhesion, or the press-fit method or the like to the inner surface of the protectively-colored cover 85. Thus, the candid camera 83 can be installed in the meter housing 81 without using the partition wall 82.

### INDUSTRIAL APPLICABILITY

As described above, the image processing system for identifying car thieves in this invention has the following practical and beneficial effects.

(a) Even if the car is stolen, a full-face image of the criminal can be taken by the system without him knowing it.

(b) Even if it is dark, the clear image of the criminal can be recorded.

What is claimed is:

1. An image processing system for identifying car thieves characterized by comprising a dashboard panel being provided in front of the driver's seat, a candid camera being provided behind the dashboard panel, and an infrared light projector emitting infrared light toward the driver's seat, therein a hole is provided at a specific position on the dashboard panel so that the candid camera is appropriately set to face the driver's seat, and the hole being covered with a protectively-colored cover made of a translucent material and of the similar or the same color as that of the dashboard panel.

2. An image processing system for identifying car thieves of claim 1 characterized by an infrared light projector being provided behind the hole facing the driver's seat.

3. An image processing system for identifying car thieves of claim 1 characterized by a protectively-colored cover being provided on a display background of the numbers, characters, symbols or the like on the dashboard panel so that the protectively-colored cover is assimilated with the display background.

4. An image processing system for identifying car thieves of claim 1 characterized by a protectively-colored cover being preferably provided inside a circular line described as a number, such as “0” or “8” or the like.

5. An image processing system for identifying car thieves of claim 1 characterized by a protectively-colored cover being shaped like a convex lens projecting toward the driver's seat.

6. An image processing system for identifying car thieves of claim 1 characterized by a candid camera that starts taking moving images from standby mode controlled by a prior-switch operation near the driver's seat as the criminal opens the door and with the camera ceasing operation as the criminal opens the door again after he has stopped the car and turns off the engine switch.

7. An image processing system for identifying car thieves of claim 1 characterized by a candid camera taking an image of the thief as:
a. the criminal sits in the driver's seat and turns the key to start the engine, or
b. the criminal steps on the brake pedal, thus turning on the stop lights.

8. An image processing system for identifying car thieves of claim 1 characterized by a candid camera comprising a means of transmitting still images of a criminal sitting in the driver's seat to the computer or mobile terminal of the car owner.

9. An image processing system for identifying car thieves of claim 1 characterized by a candid camera being housed in an indicator light case of the dashboard panel, and a hole being provided on a light cover of the indicator light case, the hole being covered with a protectively-colored cover of the similar or the same color as that of the light cover.

10. An image processing system for identifying car thieves of claim 1 characterized by a candid camera being fixed on a partition wall in the meter housing of the dashboard panel.

11. An image processing system for identifying car thieves of claim 1 characterized by an imitation protectively-colored cover being provided at a specific place on the dashboard panel.
